(19) United States
(12) Patent Application Publication
(10) Pub. No.: US 2026/0133080 A1
(43) Pub. Date: May 14, 2026

(54) PULL TAB ACTIVATABLE ENVIRONMENTAL EXPOSURE INDICATORS

(71) Applicant: Zebra Technologies Corporation, Lincolnshire, IL (US)

(72) Inventors: Brian S. Huffman, Belle Mead, NJ (US); Sean MacDavitt, Locust Valley, NY (US); Mohannad Abdo, Clifton, NJ (US)

(73) Assignee: Zebra Technologies Corporation, Lincolnshire, IL (US)

(21) Appl. No.: 18/947,245

(22) Filed: Nov. 14, 2024

(51) Int. Cl. G01K 11/06

(52) U.S. Cl. CPC G01K 11/06

(57) ABSTRACT

Pull tab activatable environmental exposure indicators are provided herein. An example pull tab activatable environmental exposure indicator includes a substrate, a first indicator region and a second indicator region defined on the substrate, a first reservoir containing a first payload including a first liquefiable material configured to liquefy responsive to a first predetermined environmental exposure, a second reservoir containing a second payload including a second liquefiable material configured to liquefy responsive to a second predetermined environmental exposure, and a removable sealing layer, the removable sealing layer preventing flow of the first payload from the first reservoir to the first indicator region when the first liquefiable material is liquefied and prevents flow of the second payload from the second reservoir to the second indicator region when the second liquefiable material is liquefied.

### BACKGROUND

Environmental indicators may be configured to indicate the occurrence of an environmental exposure to a host product. Prior to the association between the host product and the indicator, the same level of care must often be paid to the indicator to prevent an exposure to the environmental condition which the indicator is configured to indicate, so that the indicator is not triggered prematurely and rendered unusable for use with the host product. For example, high temperature exposure indicators may need to be kept in deep freeze or refrigerated conditions, complicating the component supply chains for the products they are used with. Activatable environmental indicators have been previously proposed.

### SUMMARY

In a first embodiment, the technology of the present disclosure is provided by an activatable environmental exposure indicator, including a substrate, a first indicator region and a second indicator region defined on the substrate, a first reservoir containing a first payload including a first liquefiable material configured to liquefy responsive to a first predetermined environmental exposure, a second reservoir containing a second payload including a second liquefiable material configured to liquefy responsive to a second predetermined environmental exposure, and a removable sealing layer, the removable sealing layer preventing flow of the first payload from the first reservoir to the first indicator region when the first liquefiable material is liquefied and prevents flow of the second payload from the second reservoir to the second indicator region when the second liquefiable material is liquefied. Removing the removable sealing layer permits flow of the first liquefiable material from the first reservoir to the first indicator region and from the second liquefiable material from the second reservoir to the second indicator region. Responsive to an exposure to the first predetermined environmental exposure after the removable sealing layer is removed, flow of the first liquefiable material from the first reservoir to the first indicator region produces a first observable effect. Responsive to an exposure to the second predetermined environmental exposure after the removable sealing layer is removed, flow of the second liquefiable material from the second reservoir to the second indicator region produces a second observable effect.

In a second embodiment, the technology of the present disclosure is provide by an activatable environmental exposure indicator, including a substrate, a sliding layer, translatable between a first configuration and a second configuration, a first reservoir, containing a first payload including a first liquefiable material configured to liquefy responsive to a first predetermined environmental exposure, an indicator region, separated from the first reservoir when the sliding layer is in the first configuration. The first reservoir is coupled to and translatable with the sliding layer, and the indicator region is disposed on the substrate, or the indicator region is disposed on and translatable with the sliding layer and the first reservoir is coupled to the substrate. The activatable environmental exposure indicator includes a second reservoir, containing a second payload including a second liquefiable material configured to liquefy when exposed to a second predetermined environmental exposure and solidify when not exposed to the second predetermined environmental exposure, and a migration region, separated from the second reservoir when the sliding layer is in the first configuration. The second reservoir is coupled to and translatable with the sliding layer, and the migration region is disposed on the substrate, or the migration region is disposed on and translatable with the sliding layer, and the second reservoir is coupled to the substrate. When the sliding layer is in the second configuration, the first reservoir contacts with the indicator region, and the second reservoir contacts the migration region. When the first reservoir is in contact with the indicator region and the first liquefiable material is liquefied, the first liquefiable material migrates into the indicator region and produces an observable effect. When the second reservoir is in contact with the migration region and the second liquefiable material is liquefied, the second liquefiable material migrates into migration region. The second liquefiable material is configured to migrate through the migration region at a predetermined rate, such that a distance along the migration region through which the second liquefiable material has migrated corresponds to a cumulative duration of exposures to the second predetermined environmental exposure.

In an example aspect of the first and second embodiments, the removable sealing layer includes a frangible bond which couples the removable sealing layer to the substrate.

In an example aspect of the first and second embodiments, the removable sealing layer is coupled to the substrate in a manner which prevents evaporation of at least one of the first payload and the second payload.

In an example aspect of the first and second embodiments, the first reservoir includes a first wick reservoir portion at least partially saturated with the first payload.

In an example aspect of the first and second embodiments, the second reservoir includes a second wick reservoir portion at least partially saturated with the second payload.

In an example aspect of the first and second embodiments, a first wick indicator portion is located at the first indicator region.

In an example aspect of the first and second embodiments, a second wick indicator portion is located at the second indicator region.

In an example aspect of the first and second embodiments, the first reservoir is biased towards the first wick indicator portion by a first biasing element.

In an example aspect of the first and second embodiments, the second reservoir is biased towards the second wick indicator portion by a second biasing element.

In an example aspect of the first and second embodiments, the activatable environmental exposure indicator further includes a cover layer, the cover layer including transparent portions through which at least a portion of the first indicator region and at least a portion of the second indicator region is viewable through the cover layer.

In an example aspect of the first and second embodiments, prior to removal, the removable sealing layer includes a first terminal end attached to a first location on the substrate and an intermediate portion coupled to a second location on the substrate by a frangible bond, the first terminal end and the intermediate portion defining a sealing portion that seals the first and second reservoirs; and a pull tab extending from the intermediate portion to a second terminal end, the pull tab folded over the sealing portion such that the first and second terminal ends are proximate to each other and the seal is disengaged in response to a force being applied to the pull tab.

In an example aspect of the first and second embodiments, prior to removal, the removable sealing layer is coupled to the substrate such that the first reservoir and the second reservoir are enveloped between the removable sealing layer and the substrate, and when a force is applied to an exposed portion of the removable sealing layer, the removable sealing layer is separated from the substrate and removed.

In an example aspect of the first and second embodiments, the activatable environmental exposure indicator further includes a portion of the substrate defined by a line of weakness, wherein frangible bond is disposed in the portion of the substrate defined by the line of weakness, and wherein the portion of the substrate is configured to be torn along the line of weakness, such that when the portion of the substrate is torn along the line of weakness, the frangible bond is disengaged and the removable sealing layer is uncoupled from the substrate.

In an example aspect of the first and second embodiments, the activatable environmental exposure indicator further includes a second portion of the substrate defined by a second line of weakness, wherein the second portion of the substrate is configured to be torn along the second line of weakness, such that when the second portion of the substrate is torn along the line of weakness, the second portion of the substrate separates from a remainder of the substrate but remains attached to the removable sealing layer, such that the sealing layer is removable by drawing the sealing layer out of the activatable environmental exposure indicator via the second portion of the substrate.

In an example aspect of the first and second embodiments, the first indicator region includes a first migration region, and the first predetermined environmental exposure is an exposure to a temperature above a first predetermined temperature threshold, such that when the first payload is at a temperature above the first predetermined temperature threshold, the first liquefiable material is liquefied and the first payload migrates through the first migration region at a predetermined rate, and when the first payload is at a temperature below the first predetermined temperature threshold, the first liquefiable material is solidified, and the first payload halts migration through the first migration region, such that a distance through the first migration region which the first payload has migrated corresponds to an amount of time which the first payload has been at temperatures above the first predetermined temperature threshold.

In an example aspect of the first and second embodiments, the second indicator region includes a second migration region, and the second predetermined environmental exposure is an exposure to a temperature above a second predetermined temperature threshold, such that when the second payload is at a temperature above the second predetermined temperature threshold, the second liquefiable material is liquefied and the second payload migrates through the second migration region at a predetermined rate, and when the second payload is at a temperature below the second predetermined temperature threshold, the second liquefiable material is solidified, and the second payload halts migration through the second migration region, such that a distance through the second migration region which the second payload has migrated corresponds to an amount of time which the second payload has been at temperatures above the second predetermined temperature threshold.

In an example aspect of the first and second embodiments, the first payload is configured to rapidly migrate into the first indicator region and produce the first observable effect responsive to a single exposure to the first predetermined environmental exposure occurring after the removable sealing layer is removed.

In an example aspect of the first and second embodiments, the second payload is configured to rapidly migrate into the second indicator region and produce the second observable effect responsive to a single exposure to the second predetermined environmental exposure occurring after the removable sealing layer is removed.

In an example aspect of the first and second embodiments, the first reservoir and the second reservoir are isolated from one another by a membrane, the membrane configured to isolate the first payload from the second payload.

In an example aspect of the first and second embodiments, the first predetermined environmental exposure and the second predetermined environmental exposure are selected from a group consisting of a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

In an example aspect of the first and second embodiments, the first liquefiable material and the second liquefiable material include materials selected from a group consisting of a side-chain crystallizable polymer, an alkane, a wax, an alkane wax, esters, other polymeric materials, and combinations thereof.

In an example aspect of the first and second embodiments, the first payload includes a first indicator material combined with the first liquefiable material, the first indicator material configured to be transported to the first indicator region by the first liquefiable material when the first liquefiable material is liquefied, and the removable sealing layer is removed and produce the first observable effect in the first indicator region.

In an example aspect of the first and second embodiments, the second payload includes a second indicator material combined with the second liquefiable material, the second indicator material configured to be transported to the second indicator region by the second liquefiable material when the second liquefiable material is liquefied, and the removable sealing layer is removed and produce the second observable effect in the second indicator region.

In an example aspect of the first and second embodiments, the first predetermined environmental exposure is an exposure to a temperature above a first predetermined high temperature threshold, and the second predetermined environmental exposure is an exposure to a temperature above a second predetermined high temperature threshold, lower than the first predetermined high temperature threshold.

In an example aspect of the first and second embodiments, the activatable environmental exposure indicator further includes a cover layer, the cover layer including at least one of a) a first transparent portion through which the indicator region is viewable and b) a second transparent portion through which at least a portion of the migration region is viewable.

In an example aspect of the first and second embodiments, the sliding layer includes an exposed portion which protrudes beyond the substrate, configured such that when a force is applied in a predetermined direction to the exposed portion, the sliding layer is transitioned from the first configuration to the second configuration.

In an example aspect of the first and second embodiments, the sliding layer is coupled to the substrate by a frangible bond, such that the sliding layer is transitioned from the first configuration to the second configuration only when the force exceeds a predetermined force threshold sufficient to disengage the frangible bond.

In an example aspect of the first and second embodiments, the first liquefiable material includes a material selected from a group consisting of a side-chain crystallizable polymer, an alkane, a wax, an alkane wax, esters, other polymeric materials, and combinations thereof.

In an example aspect of the first and second embodiments, the activatable environmental exposure indicator further includes an indicator material, mixed with the first liquefiable material, configured to produce an observable effect in the indicator region when the first liquefiable material liquefies and migrates to the indicator region.

In an example aspect of the first and second embodiments, the second liquefiable material includes a material selected from a group consisting of a side-chain crystallizable polymer, an alkane, a wax, an alkane wax, esters, other polymeric materials, and combinations thereof.

In an example aspect of the first and second embodiments, the activatable environmental exposure indicator further includes an indicator material mixed with the second liquefiable material, configured to indicate a portion of the migration region through which the second liquefiable material has migrated.

In an example aspect of the first and second embodiments, the first predetermined environmental exposure is selected from a group consisting of a temperature excursion above a predetermined temperature, a temperature excursion below a predetermined temperature, an exposure to a particular chemical, an oxygen exposure, an ammonia exposure, an exposure to a particular chemical above a threshold concentration, a predetermined electromagnetic exposure, a humidity exposure, and an exposure to a humidity level above a predetermined threshold.

In an example aspect of the first and second embodiments, the second predetermined environmental exposure is selected from a group consisting of a temperature excursion above a predetermined temperature, a temperature excursion below a predetermined temperature, an exposure to a particular chemical, an oxygen exposure, an ammonia exposure, an exposure to a particular chemical above a threshold concentration, a predetermined electromagnetic exposure, a humidity exposure, and an exposure to a humidity level above a predetermined threshold.

In an example aspect of the first and second embodiments, the first predetermined environmental exposure is an exposure to a temperature above a first predetermined high temperature threshold, and the second predetermined environmental exposure is an exposure to a temperature above a second predetermined high temperature threshold, lower than the first predetermined high temperature threshold.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIGS. 1A-B illustrate a first embodiment of an activatable environmental exposure indicator, according to embodiments of the present disclosure.

FIGS. 2A-C illustrate a second embodiment of an activatable environmental exposure indicator, according to embodiments of the present disclosure.

FIGS. 3A-B illustrate a third embodiment of an activatable environmental exposure indicator, according to embodiments of the present disclosure.

FIGS. 4A-B illustrate a fourth embodiment of an activatable environmental exposure indicator, according to embodiments of the present disclosure.

FIGS. 5A-B illustrate a fifth embodiment of an activatable environmental exposure indicator, according to embodiments of the present disclosure.

FIG. 6A illustrates an exploded view of a sixth embodiment of an activatable environmental exposure indicator, according to embodiments of the present disclosure.

FIGS. 6B-6C illustrate various stages of activation of the sixth embodiment of an activatable environmental exposure indicator, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to an activation platform for environmental indicators, such as peak temperature exposure and time-temperature indicators. Environmental indicators (e.g., indicators incorporating an indicator material that liquifies in response to a predetermined environmental exposure) may be configured to indicate the occurrence of such a predetermined environmental exposure to a host product, e.g., by changing appearance or by changing an electrical property of the indicator which may be detected by an appropriate circuit or computer. Prior to the association between the host product and the indicator, the same level of care must be paid to the indicator to prevent an exposure to the environmental condition of which the indicator is configured to indicate, such that the indicator is not spent prematurely and rendered unusable with the host product. Said differently, if a thermal indicator is to be installed on a host product, the indicator may need to be held below the temperature at which the thermal indicator is configured to indicate prior to installation of the indicator on or with a monitored host product. If a sufficient thermal exposure were to occur prior to pairing with the host product, the indicator would transition to an indicative state prior to installation, and, provided the indicator is an irreversible indicator, the indicator would be expended prior to use. For example, indicators configured for use with refrigerated items, e.g., indicators showing when host products have warmed above a refrigerator temperature, the indicators generally need to be refrigerated prior to being paired with a host product, which results in an additional cost and more complicated inventory management and manufacturing process for the user. Using an indicator that requires an application of an activation action before becoming sensitive to environmental exposure may help avoid these problems.

The indicators of the present disclosure are generally activatable environmental exposure indicators housing two or more types of activatable indicator. The environmental exposure indicators can be simultaneously activatable by a single activation action or step or can be independently activatable by one or more activation actions or steps. The activatable environmental exposure indicators may be configured to indicate two or more types of environmental exposure, such as a peak temperature excursion exposure, as well as an exposure to temperatures above a predetermined threshold for at least a predetermined amount of time. Such indicators may be useful in applications involving host products having more than one environmental sensitivity.

The activatable environmental exposure indicators of the present disclosure employ sealing layers in various configurations to activate the activatable environmental exposure indicator. Generally, the sealing layer is a removable (e.g., semi-removable or entirely removable) component having a sealed configuration prior to removal and having an unsealed configuration after removal. In the sealed configuration, the sealing layer prevents contact between a payload of the indicator and an indicator region of the indicator. In the unsealed configuration, the sealing layer is removed, and the payload contacts the indicator region. When the sealing layer is in the unsealed configuration, and responsive to the activatable environmental exposure indicator being exposed to a predetermined environmental exposure, the payload migrates into the indicator region, either almost immediately, or over a period of time, producing an observable effect, (e.g., a change of color state in the indicator region, or the migration region).

In some embodiments of the present disclosure, the payload is environmentally sensitive, or contains environmentally sensitive materials, which exhibit a phase change responsive to a predetermined environmental exposure. The indicators may be configured, along with, in some embodiments, other materials contained in the payload, to produce or display an observable effect responsive to the phase change resulting from the predetermined environmental exposure. The sealing layers, prior to being removed, are generally configured to prevent this production or display of the observable effect, regardless of exposures of the payload to the predetermined environmental exposure. Once the sealing layer is removed, and the payload is exposed to the indicator region. In this manner, the indicators are activatable, as the removal of the sealing layer may be controlled by a user, such that the indicator does not become environmentally sensitive until the activation action which transitions the sealing layer to the unsealed configuration is applied.

In some embodiments, the payload material may include one or more volatile components. Over time, these components may evaporate, reducing the accuracy or effectiveness of the indicator. By providing a partial or complete seal over the payload, this effect may be partially or completely overcome prior to the activation of the device, thereby increasing the useful shelf life of the indicator prior to its deployment with a host product.

The discussion contained in the following detailed description has been organized as follows:
Section I: Some Relevant Materials and Notable Properties Thereof.
Section II: Embodiments of Activatable Environmental Exposure Indicators.

### Section I: Some Relevant Materials and Notable Properties Thereof

### Liquefiable Materials

Various embodiments of activatable environmental exposure indicators discussed herein utilize a liquefiable material that can be configured to react to an environmental exposure temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. However, notwithstanding a relatively quick response by the liquefiable material to heat, some indicators discussed herein exhibit a time-dependent response that halts when conditions return below the environmental exposure temperature threshold and resumes again in an additive manner. Again, in some embodiments, this is due to the liquefiable material having a sharp transition between a liquid phase and a solid phase.

For example, where an indicator is configured to signal a response after an exposure of about 30 minutes at and/or above the environmental exposure temperature threshold, a 20-minute exposure will not trigger an observable response in the indicator region, but if the indicator is again exposed to a temperature at and/or above the environmental exposure temperature threshold, a reduced amount of exposure, e.g., about 10 more minutes of exposure may yield a response. In some embodiments as noted above, this behavior is achieved because the liquefiable solid (such as a side-chain crystalline polymer) readily liquifies and solidifies within a narrow temperature range. Once the environmental exposure temperature has been exceeded, a drop in temperature below the environmental exposure will cause almost immediate cessation of the time-dependent response with such materials. The response will resume once the environmental exposure temperature threshold is again exceeded.

As used herein, the terms “predetermined environmental exposure” and “environmental exposure temperature threshold” have an understood meaning in the art and include a temperature, usually a temperature above 0° C. (though temperatures below 0° C. are also contemplated), that can cause damage or harm to a product, such as a food or a vaccine that may require refrigeration to avoid spoilage or maintain efficacy for extended periods. The term “environmental exposure temperature threshold,” then, can include any predetermined temperature that is above a desired storage temperature of a perishable product, though in some cases exposure for short periods of time may not damage or harm a particular product. Thus, some embodiments disclosed herein can be configured to provide signal of exposure to temperatures at and/or above an environmental exposure temperature threshold only after a specified amount of time even if exposure occurs at different times.

In some embodiments, the liquefiable material has a “sharp” liquefaction point, meaning that the transition from solid to liquid happens very quickly over a very small temperature range. In some embodiments, liquefaction temperature and solidification temperature of the liquefiable solid are identical. In some embodiments, the liquefaction and solidification temperatures are within about 0.1° C., within about 0.5° C., within about 1.0° C., within about 1.5° C., within about 2° C., within about 2.5° C., within about 3.0° C., within about 3.5° C., within about 4.0° C., within about 4.5°C., within about 5° C., or within about 10° C. of each other.

As used herein, the term “solid phase” may refer to a material in a non-liquid state such that the material is incapable of fluid flow. In some examples “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “liquid phase” is used to describe a state of a material in which the material is capable of fluid flow. Similarly, the terms “liquefaction” and “liquefy” are used to describe the transition in which a material not in the liquid phase enters the liquid phase. The terms “liquefaction point” and “liquefaction temperature” are used to describe a temperature, or temperature range, at or in which a material may undergo liquefaction.

Some suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable, as defined here. Useful synthetic polymers can also be hydrophobic, if desired. Some suitable liquefiable materials include side-chain crystallizable polymers (e.g., various methacrylates, such as poly(hexadecylmethacrylate); a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms).

As used herein, the term “polymer”, and its linguistic variations, refers to copolymers, and higher order polymers, as well as homopolymers, unless the context indicates otherwise, for example, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some examples of SCC polymers include poly(dodecylacrylate), poly(tetradecylacrylate) , poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer oftetradecylacrylate and octadecylacrylate, copolymer oftetradecylacrylate and octadecylacrylate, copolymer oftetradecylacrylate and octadecylacrylate, poly(dodecylmethacrylate), poly(tetradecylmethacrylate), poly(hexadecylmethacrylate), poly(octadecylmethacrylate), copolymer of tetradecylmethacrylate and methyl methacrylate, copolymer of octadecylmethacrylate and methyl methacrylate.

For example, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8: 117-253 (1974), the disclosure of which is hereby incorporated by reference. In general, these polymers contain monomer units X of the formula:

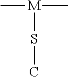

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide-will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10: 3347 (1972); J. Poly. Sci 10: 1657 (1972); J. Poly. Sci 9: 3367 (1971); J. Poly. Sci 9: 3349 (1971); J. Poly. Sci. 9: 1835 (1971); J.A.C.S. 76: 6280 (1954); J. Poly, Sci 7: 3053 (1969); Polymer J. 17: 991 (1985), corresponding acryl amides, substituted acrylamide and maleimide polymers (J. Poly. Sci: Poly. Physics Ed. 18: 2197 (1980)); polyalphaolefin polymers such as those described in J. Poly. 5,156,911 7 Sci. Macromol. Rey, 8: 117-253 (1974) and Macromolecules 13: 12 (1980), polyalkylvinylethers, polyalkylethylene oxides such as those described in Macromolecules 13: 15 (1980), alkylphosphazene polymers, polyamino acids such as those described in Poly. Sci. USSR 21: 241, Macromolecules 18: 2141, polyisocyanates such as those described in Macromolecules 12: 94 (1979), polyurethanes made by reacting amine-or alcohol-containing monomers with long-chain alkyl isocyanates, polyesters and polyethers, polysiloxanes and polysilanes such as those described in Macromolecules 19: 611 (1986), and p-alkylstyrene polymers such as those described in J.A.C.S. 75: 3326 (1953) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O(CO)— and —NR— where R is hydrogen or lower alkyl (1-6C), and -M- is —[(CH₂)ₘ—CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc.

Other suitable liquefiable materials may be alkanes waxes alone, without SCCs, or alkane waxes blended with SCCs.

### Indicator Materials

According to some embodiments, the indicators disclosed herein contain a payload including both a liquefiable material and an accompanying indicator material. When in the solid state, the liquefiable material may substantially prevent movement, migration or diffusion of the indicator material through the liquefiable material. When the liquefiable material is in the liquid state, the indicator material may be able to migrate, move or diffuse through the liquefiable material, and in some examples the indicator material is transportable by the liquefiable material.

Generally, an indicator material produces or facilitates the production of a detectable indication, e.g., a change in color state or electrical property, in response to a predetermined environmental stimulus, e.g., heating above a threshold temperature. When combined with a liquefiable material, the indicator material is configured to produce, either alone or in combination with other elements, a detectable indication when the liquefiable material liquefies (e.g., in response to a predetermined environmental exposure).

The simplest form of indicator material may be a colorant, dye, or other material that may be transported by the liquefiable material.

Some embodiments of indicator materials discussed here utilize two or more compounds capable of reacting with each other to yield a color change. In some examples, the two or more reactants may be separated and prevented from mutual contact by a liquefiable material in a solid state. In some embodiments two or more reactants may be contained in distinct locations, which may substantially prevent the compounds from interacting prior to the activation of the activatable environmental exposure indicator.

Used in combination with the liquefiable material, in some embodiments, are color-reacting materials, such as two reactants kept separate but allowed to react with each other after activation or migration. Dyes can also be dissolved in such liquefiable materials to provide an intense color. In some embodiments, the color-reacting materials, or color-forming reactants, produce a distinct color change or change in opacity when brought into contact with each other. A common example is the use of a leuco dye system.

When the reactants come into contact, the appearance change of the indicator may be to go from clear to black, from clear to a dark color, from a light color to a dark color, from a light color to black, etc. In some embodiments, a background is visible through the liquefiable layer(s) prior to the reaction, thereby indicating that the predetermined temperature threshold and required exposure period have not yet been satisfied. The background may include words, numbers, or a pattern, or may simply comprise a color that is easily obscured by the color-forming reaction of the reactants. In some embodiments, a pattern on the background is at least partially obscured by the light color of the liquefiable layer(s), and the pattern becomes more visible after the color-forming reaction. For example, if the pattern is formed with an ink having a color similar to the color of the pre-reacted reactants, a color change produced by the interaction of the color-forming reactants may render the pattern more visible.

In some examples, the liquefiable material may also serve as an indicator material. Some liquefiable materials exhibit visibly detectable changes when undergoing a phase change, such as changes in opacity. Some indicators of the present disclosure may rely on such visibly detectable changes of the liquefiable material as the production of the observable effect, and include components configured to visually emphasize the visibly detectable change when the change occurs.

Some embodiments discussed herein utilize conductive particles which, when employed in tandem with a liquefiable material, may be held separately from one another when the liquefiable material is in the solid phase, and be configured to form an electrical connection between two electrodes when the liquefiable material is in the liquid phase. Thus, by measuring the conductivity between the two electrodes, the state of the liquefiable material can be determined, or rather, an exposure of the liquefiable material to the predetermined environmental exposure may be confirmed. According to some embodiments, the conductive particles may include particles of conductive metals, such as copper, silver, gold, aluminum, zinc, tin, similar metals, and alloys thereof. The conductive particles may also include particles of graphene, graphite, carbon black, graphene oxides, and other functionalized graphenes, and particles containing conductive non-metals. The conductive particles may be formed in whole or in part by any electrically conductive substance or material operable to be particlized to a sufficient size to fit within the shell of a microcapsule.

Some embodiments of indicator materials discussed herein utilize colored or bright materials, such as dyes, flash materials, and other colorants. In some examples, liquefaction of the liquefiable material may result in a change in opacity of the liquefiable material, which may reveal or obscure the indicator material. In some examples, the liquefiable material may transport the indicator material from a non-viewable or concealed location to a viewable location when in the liquid state.

### Section II: Embodiments of Activatable Environmental Exposure Indicators

### Activatable Environmental Exposure Indicator: First Embodiment

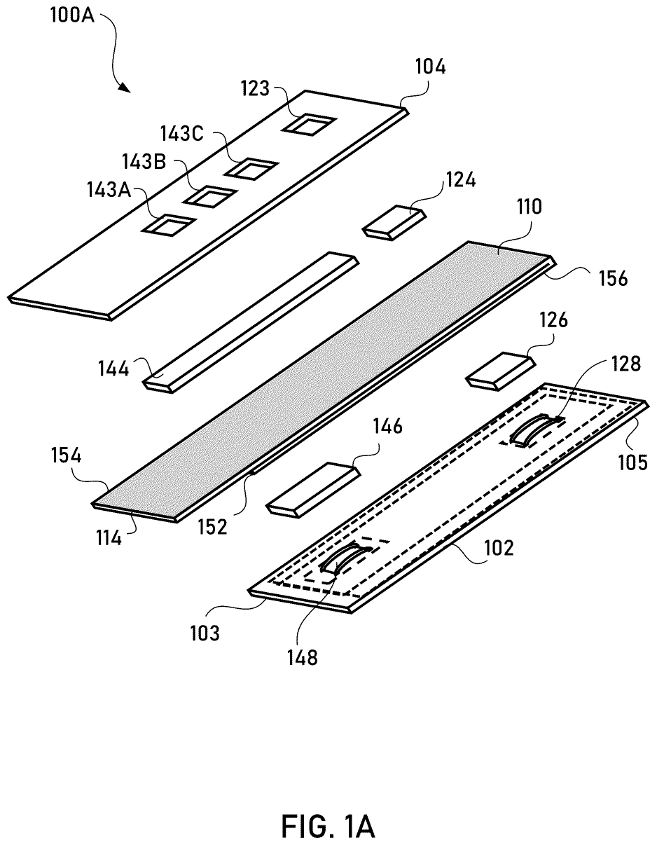

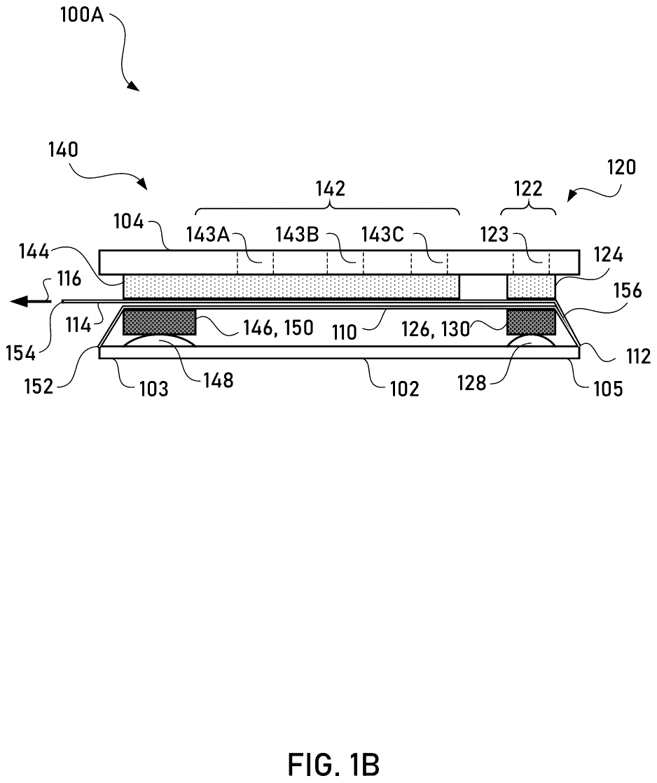

FIG. 1A illustrates an exploded view of a first embodiment of an activatable environmental exposure indicator 100A (e.g., thermal exposure indicator), according to embodiments of the present disclosure. FIG. 1B illustrates a cross-sectional view of the first embodiment of the activatable environmental exposure indicator 100A, according to embodiments of the present disclosure. The activatable environmental exposure indicator 100A contains an excursion exposure indicator 120 (e.g., high temperature excursion indicator) and a time-dependent exposure indicator 140 (e.g., time-temperature indicator). The activatable environmental exposure indicator 100A includes a substrate 102, a cover layer 104, and a sealing layer 110 (e.g., removable sealing layer) configured to “activate” both the excursion exposure indicator 120 and the time-dependent exposure indicator 140 when the sealing layer is removed. The activatable environmental exposure indicator 100A includes a first indicator region 122 in which the excursion exposure indicator 120 is configured to produce a first observable effect, and a second indicator region 142 in which the time-dependent exposure indicator 140 is configured to produce a second observable effect. As a non-limiting example, the excursion exposure indicator 120 may be configured to indicate a single exposure to an ambient temperature above 60 degrees C, and the time-dependent exposure indicator 140 may be configured to indicate an exposure to ambient temperatures above 45 degrees C for more than one hour, more the two hours, and more than 3 hours.

Generally speaking, the excursion exposure indicator 120 is configured to indicate (e.g., via the production of the first observable effect in the first indicator region 122) that the activatable environmental exposure indicator 100A has been exposed to a first predetermined environmental exposure, where the first predetermined environmental exposure is at least a single excursion above (e.g., or below, in some examples) an exposure threshold of an environmental condition. The time-dependent exposure indicator 140 is configured to indicate (e.g., via the production of the second observable effect in the second indicator region 142) that the activatable environmental exposure indicator 100A has been exposed to a second predetermined environmental exposure, where the second predetermined environmental exposure is an exposure above (e.g., or below, in some examples) an exposure threshold of an environmental condition for at least a predetermined amount of time, for which the exposure to the environmental condition may be continuous or discontinuous.

In some examples, the first predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

In some examples, the second predetermined environmental exposure may be a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical for a predetermined period of time, an oxygen exposure lasting for a predetermined period of time, an ammonia exposure lasting for a predetermined period of time, an exposure to a particular chemical above a threshold concentration for at least a predetermined period of time, an exposure to a particular chemical above the threshold concentration for at least a predetermined amount of time, an exposure to at least a predetermined amount of radiation of a particular type for at least a predetermined amount of time, a predetermined electromagnetic exposure for at least a predetermined amount of time, and an exposure to a humidity level above a predetermined threshold for at least a predetermined amount of time.

The excursion exposure indicator 120 includes a first reservoir 126 containing a first payload 130, where the first payload 130 contains a liquefiable material which is configured to liquefy responsive to a first predetermined environmental exposure. The first liquefiable material contained in the first payload 130 may be one or more of the liquefiable materials discussed above in Section I. In the present disclosure, the first payload 130 includes a sufficient proportion of the first liquefiable material that when the liquefiable material liquefies, the second payload 150 as a whole, notwithstanding suspended or contained solids (e.g. indicator materials) being contained therein, substantially acts as a liquid. Thus, throughout the disclosure the second payload 150 may be said to liquefy. It is understood that reference to the first payload 130 liquefying or being liquefied (e.g., and other variations across parts of speech) indicates only that the first liquefiable material contained within the first payload 130 is liquefied. Such language does not imply or indicate that the first payload 130 does not contain or include non-liquid materials, nor does such language indicate that any material within the first payload 130 apart from the first liquefiable material is necessarily liquefied.

The first reservoir 126 is isolated from the first indicator region 122 by the sealing layer 110. In some embodiments, the first reservoir 126 may be configured as a wick which is saturated with the first payload 130.

According to some embodiments, the first indicator region 122 includes a first wick 124. The indicator region 122 may further include a first viewing window 123 disposed in the cover layer 104 such that the observable effect, or the results thereof, is viewable to a user viewing the activatable environmental exposure indicator 100A. In some examples the first viewing window 123 is a removed portion of the cover layer 104, or a transparent portion of the cover layer 104.

In some examples, the cover layer 104 may be formed by folded portion of the substrate 102 which includes the first wick 124 and the second wick 144, such that when the portion of the substrate 102 is folded to form the cover layer 104, the first wick 124 is aligned with the first reservoir 126 and the second wick 144 is aligned with the second reservoir 146.

In some examples, after the sealing layer 110 is removed, and responsive to the first predetermined environmental exposure, the first payload 130 liquefies and migrates into the first wick 124. As the excursion exposure indicator 120 is configured to indicate a single excursion above a predetermined threshold, the wick 124 and the first payload 130 may be configured such that the liquefied first payload 130 rapidly migrates into the first wick 124 and produces the first observable effect immediately (e.g., having a predetermined indication time, the predetermined indication time being 1 minute or less, 30 seconds or less, or 10 seconds or less).

Said differently, removing the sealing layer 110 permits flow of the first payload 130 from the first reservoir to the first indicator region 122 when the first liquefiable material is liquefied.

In various embodiments the first indicator region 122 may include other components or take other forms. In some examples the first indicator region 122 may include a destination reservoir (not shown) or other destination component for the first payload 130.

The first payload 130 is configured to produce an observable effect upon reaching the first indicator region 122. In some examples, the indicator material of the first payload 130 is a dye, ink, or other colorant, and the wick 124 appears to change from an initial color state to a second color state as the wick 124 is saturated by the first payload 130. In some examples, indicator material is a two-component dye or ink, which produces a change in color state upon mixing two reactants together. In some examples, a first reactant (e.g., a color former) and a second reactant (e.g., a color developer) are separated, and the liquefaction of the liquefiable material, the first and second reactants are mixed, producing the color change which is transferred to the first indicator region 122 as the liquefied first payload 130 migrates thereto.

In some examples, the indicator material in the first payload 130 may be a flash material, which is configured to give off a bright appearance when illuminated with light of a predetermined wavelength. In some examples, the indicator material in the first payload 130 may be a conductive material, such that the observable effect is a change in an electrical property of the first indicator region 122.

In some examples, the liquefiable material is configured or selected such that the first payload 130 remains liquefied after the predetermined environmental exposure ceases, (e.g., after the environmental condition returns to a state which does not exceed the predetermined excursion threshold). In this manner, the liquefied first payload 130 is not prevented from producing the observable effect in the first indicator region 122 due to a state change of the liquefiable material.

The time-dependent exposure indicator 140 includes a second reservoir 146 containing a second payload 150, where the second payload 150 contains a second liquefiable material which is configured to liquefy responsive to a second predetermined environmental exposure.

The second liquefiable material contained in the second payload 150 may be one or more of the liquefiable materials discussed above in Section I. In the present disclosure, the second payload 150 includes a sufficient proportion of the second liquefiable material that when the second liquefiable material liquefies, the second payload 150 as a whole, notwithstanding suspended or contained solids (e.g. indicator materials) being contained therein, substantially acts as a liquid. Thus, throughout the disclosure the second payload 150 may be said to liquefy. It is understood that reference to the second payload 150 liquefying or being liquefied (e.g., and other variations across parts of speech) indicates only that the second liquefiable material contained within the second payload 150 is liquefied. Such language does not imply or indicate that the second payload 150 does not contain or include non-liquid materials, nor does such language indicate that any material within the second payload 150 apart from the second liquefiable material is necessarily liquefied.

The second reservoir 146 is isolated from the second indicator region 142 by the sealing layer 110. In some embodiments, the second reservoir 146 may be configured as a wick which is saturated with the second payload 150.

According to some embodiments, the second indicator region 142 includes a second wick 144. The second indicator region 142 may further include a plurality of second viewing windows 143A-C (generally or collectively second viewing windows 143) disposed in the cover layer 104 such that the second observable effect, or the results thereof, is viewable to a user viewing the activatable environmental exposure indicator 100A. In some examples the second viewing windows 143 are removed portions of the cover layer 104, or transparent portions of the cover layer 104.

In some examples, after the sealing layer is removed, and responsive to the second predetermined environmental exposure, the second payload 150 liquefies and migrates into the second wick 144. As the excursion exposure indicator 120 is configured to indicate an amount of time for which the activatable environmental exposure indicator 100A is exposed to an environmental condition exceeding a predetermined threshold, the second indicator region 142 is a migration region through which the liquefied second payload 150 is configured to migrate at a predetermined rate. The second observable effect progresses through the second wick 144 such that a distance through the migration region that the liquefied second payload 150 has migrated corresponds to an amount of time for which the activatable environmental exposure indicator 100A has been exposed to the environmental condition exceeding the predetermined threshold. The second payload 150 and the second wick 144 may be configured to indicate any amount of time that the activatable environmental exposure indicator 100A is exposed to the environmental condition exceeding the predetermined threshold, but as a non-limiting example, the time-dependent exposure indicator 140 may be configured to indicate cumulative exposure durations of about 10 minutes, about 30 minutes, about 1 hour, about 3 hours, about 10 hours, or of about 14 hours.

Said differently, removing the sealing layer 110 permits flow of the second payload 150 from the second reservoir 146 to the second indicator region 142 when the second liquefiable material is liquefied.

The liquefiable material of the second payload 150 may also be configured to solidify and halt migration of the second payload 150 when the environmental condition no longer exceeds the predetermined threshold. In this manner, the second payload 150 is only liquefied and migrates through the migration region when the environmental condition exceeds the predetermined threshold and is solidified and does not migrate through the migration region when the environmental condition does not exceed the predetermined threshold. As the second payload 150 migrates through the wick 144 and the migration region, the second payload 150 may cause the production of the second observable effect in the portions of the second wick 144 through which the second payload 150 has migrated, and the portions of the second wick 144 which the second payload 150 has not migrated through remain in an initial state, where the observable effect has not (e.g., not yet) been produced.

The activatable environmental exposure indicator 100A may include various indices which correspond to different amounts of time that the activatable environmental exposure indicator 100A has been exposed to the environmental condition exceeding the predetermined threshold. In some examples, the plurality of second viewing windows 143 includes a single window through which the migration region is viewable, and the cover layer includes printed indicia corresponding to locations within the migration region such that a the distance along the second wick 144 that the payload has travelled is correlated to a specific interval of time which the activatable environmental exposure indicator 100A has been exposed to the environmental condition exceeding the predetermined threshold. In some examples, the plurality of second viewing windows 143 includes several second viewing windows 143, each second viewing window 143 disposed at a predetermined location relative to the second wick 144 and the migration region, such that when the second observable effect is viewable through a given second viewing window 143, a user may determine that the activatable environmental exposure indicator 100 has been exposed to the environmental condition exceeding the predetermined threshold for at least the predetermined amount of time which corresponds to the given second viewing window 143.

In various embodiments the second indicator region 142 may include other components or take other forms. In some examples the second indicator region 142 and the migration region may include microchannels configured to support migration of the liquefied second payload 150.

The second payload 150 is configured to produce an observable effect upon reaching the second indicator region 142. In some examples, the indicator material of the second payload 150 is a dye, ink, or other colorant, and the second wick 144 appears to change from an initial color state to a second color state as the second wick 144 is saturated by the second payload 150′. In some examples, the indicator material is a two-component dye or ink, which produces a change in color state upon mixing two reactants together.

In some examples, the indicator material in the second payload 150 may be a flash material, which is configured to give off a bright appearance when illuminated with light of a predetermined wavelength. In some examples, the indicator material in the second payload 150 may be a conductive material, such that the observable effect is a change in an electrical property of the second indicator region 142.

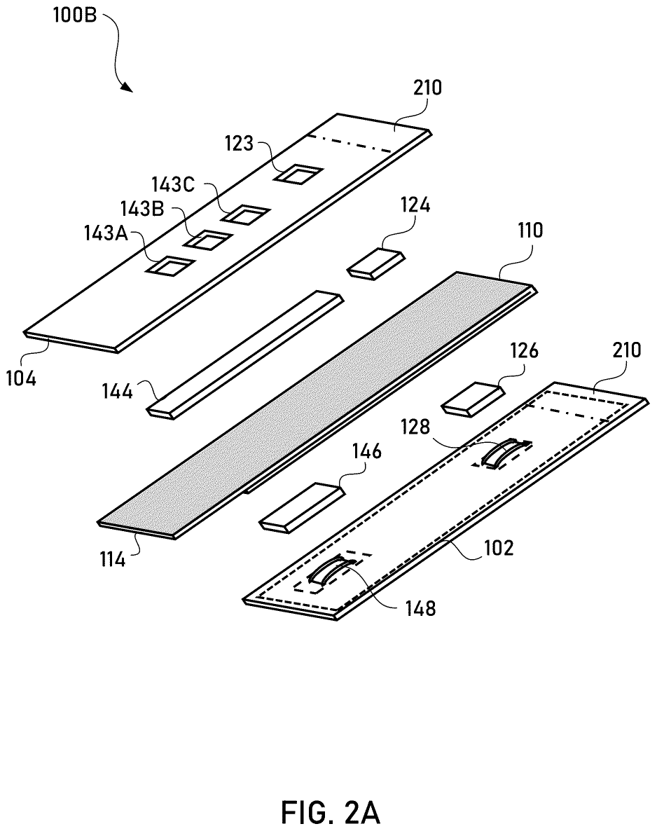

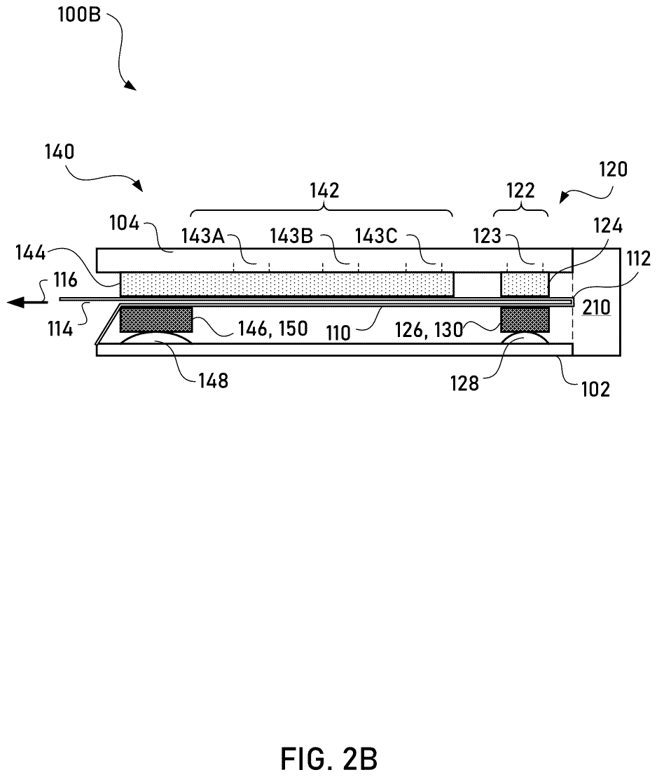

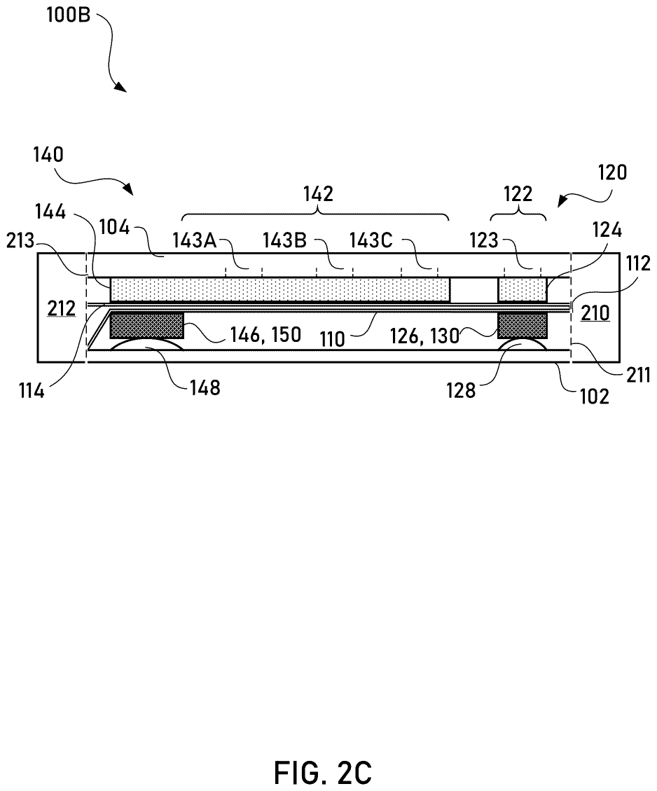

The first reservoir 126 and the second reservoir 146 are both respectively isolated from the first indicator region 122 and the second indicator region 142 by the sealing layer 110. In some examples, and the first reservoir 126 is separated from the second reservoir 146 by a membrane or similar structure. The sealing layer 110 is sealed to the substrate 102, such that the sealing layer 110 is secured to the substrate 102 by a frangible bond 112. The frangible bond 112 is configured such that a user may apply a force to a pull tab 114 of the sealing layer 110 in a direction 116, which is sufficient to break the frangible bond 112 and remove the sealing layer 110 from the activatable environmental exposure indicator 100A. In some embodiments, the pull tab 114 secured to a tearable tab (e.g., similar to tearable tab 212 shown in FIG. 2C) that at least partially seals the interior volume of the activatable environmental exposure indicator 100 to prevent and/or mitigate the introduction of foreign materials into the interior volume. In some embodiments removal of the sealing layer 110 results in total separation of the sealing layer 110 from the activatable environmental exposure indicator 100A, and in other embodiments the sealing layer may remain attached at a point of attachment in a manner that does not block the first reservoir 126 from contact with the first indicator region 122 nor block the second reservoir 146 from contact with the second indicator region 142.

According to some embodiments, the sealing layer 110 is doubled over, and a portion of the frangible bond 112 is disposed at a fold of the sealing layer 110. In this manner, leverage may be applied to the sealing layer 110 when applying a force in the direction 116 to the pull tab 114, reducing the amount of force required to break the frangible bond 112 and remove the sealing layer 110 from the activatable environmental exposure indicator 100. As an example, the sealing layer 110 can have an elongated body and can include a first terminal end 152 and a second terminal end 154 (corresponding to the pull tab 114). The first terminal end 152 of the sealing layer 110 can be sealed to the substrate 102 proximate to a first end 103 of the substrate 102 forming a first sealed end (e.g., a frangible bond 112) and can extend in a first direction towards a second end 105 of the substrate 102 over the first reservoir 126 and the second reservoir 146. An intermediate portion 156 of the sealing layer 110 (e.g., a point between the first terminal end 152 and the second terminal end 154 can be sealed to the substrate 102 at the second end 105 opposite the first end 103 and the sealing layer 110 can extend from the intermediate portion 156 in a second direction (opposite to the first direction) back towards the first end 103 of the substrate 102 such that the second terminal end 154 of the sealing layer 110 is disposed in proximity to the first terminal end 152 (e.g., as compared to the intermediate portion 156 In some examples, the sealing layer 110 can be sealed to the substrate along a length of the substrate 102 between the first sealed end and a second sealed end formed by the frangible bond 112 on each side of the first reservoir 126 and the second reservoir 146 such that the sealing layer 110 completely surrounds and seals the first reservoir 126 and the second reservoir 146. In some examples, the length along the sides of the first reservoir 126 and the second reservoir 146 are sealed by a different structure such as a seal between the cover layer 104 and the substrate 102 and the sealing layer 110 seals the first reservoir 126 and the second reservoir 146 at or near (e.g., proximate to) the first end 103 and second end 105 of the substrate 102.

In various embodiments, the first reservoir 126 and the second reservoir 146 are sealed between the substrate 102 and the sealing layer 110. In this manner, the payload is substantially insulated from the environment, thus preventing evaporation of the payload, or other potential effects of exposure prior to removal of the sealing layer 110.

According to some embodiments, the excursion exposure indicator 120 includes a first biasing element 128 and the time-dependent exposure indicator 140 includes a second biasing element. In such embodiments, the first biasing element 128 and the second biasing element 148 are configured to bias the first reservoir towards the first indicator region 122 and the second reservoir 146 towards the second indicator region 142. In this manner, the first biasing element 128 and the second biasing element 148 may improve a quality of contact between the respective reservoir and indicator region, such that when activated, each respective payload more effectively migrates into the corresponding indicator region. In some embodiments, the first biasing element 128 or the second biasing element 148 is a compressible material which is initially compressed, and decompresses when the sealing later 110 is removed, forcing the corresponding reservoir (e.g., first reservoir 126, second reservoir 146) towards the corresponding indicator region (e.g., first indicator region 122, second indicator region 142). In some embodiments, the first biasing element 128 or the second biasing element 148 is a spring.

While an example embodiment of the activatable environmental exposure indicator 100A has been illustrated with reference to FIGS. 1A-B, exemplary embodiments activatable environmental exposure indicator can include fewer, more, or different components and/or structures. As an example, in an exemplary embodiment, the sealing layer 110 can be sealed to the cover layer 104 rather than the substrate 102 (e.g., such as for embodiments in which the liquefiable and/or indicator materials are non-volatile or have low volatilities). In such embodiments, the first terminal end of the sealing layer 110 can be sealed to a first end of the cover, the intermediate portion can be sealed to a second end of the cover layer 104, and the second terminal end can be folded over such that the second terminal end is in proximity to the first terminal end.

Although illustrated as substantially open-ended for simplicity, it is noted that the activatable environmental exposure indicator 100A may be sealed about a perimeter of the activatable environmental exposure indicator 100, such that all of the components contained between the cover layer 104 and the substrate 102 are sealed therebetween. In some embodiments, the substrate 102 and cover layer 104 can be separate and distinct components that are sealed together about the perimeter. In some embodiments, the substrate 102 and cover layer 104 can be formed by a single sheet of material that is folded upon itself and subsequently sealed about its perimeter.

### Activatable Environmental Exposure Indicator: Second Embodiment

FIG. 2A illustrates an exploded view of a second embodiment of an activatable environmental exposure indicator 100B, according to embodiments of the present disclosure. FIG. 2B illustrates a cross-sectional view of the second embodiment of the activatable environmental exposure indicator 100B, according to embodiments of the present disclosure. Generally speaking, the activatable environmental exposure indicator 100B operates similarly to the activatable environmental exposure indicator 100A but differs in construction. Except where noted in the following, the discussion of the first embodiment of the activatable environmental exposure indicator 100A and the components, properties, and features thereof, apply to the second embodiment of the activatable environmental exposure indicator 100B.

The second embodiment of the activatable environmental exposure indicator 100B includes a tearable tab 210 disposed oppositely to the pull tab 114. The tearable tab 210 contains or is operatively coupled to the frangible bond 112, such that when the tearable tab 210 is torn and removed from the activatable environmental exposure indicator 100B, the frangible bond is disengaged, and the sealing layer 110 may be removed by applying a force to the pull tab 114 in the direction 116. Disengaging the frangible bond 112 by removing the tearable tab 210 may reduce the force required to remove the sealing layer 110, as the force applied to the pull tab 114 in the direction 116 does not necessarily have to be of sufficient magnitude to break the frangible bond 112, only of sufficient magnitude to remove the sealing layer 110 which is unsecured. The tearable tab 210 may be made of a material consistent with the substrate 102 or cover layer 104, and delineated therefrom by a line of weakness, such as perforated line, a fold or a score, along which the tearable tab 210 may be torn to remove the tearable tab 210 from the activatable environmental exposure indicator 100B. As an example, the tearable tab 210 can be formed by lines of weakness 211 and 213 (e.g., folds, perforations, and/or scores) in the substrate 102 and cover layer 104 that align with each other when the cover layer 104 is secured to the substrate 102.

In some embodiments, the activatable environmental exposure indicator 100B can include another tearable tab 212 at the opposing end of the activatable environmental exposure indicator 100B that captures and is secured to the pull tab 114, e.g., as shown in FIG. 2C. The tearable tab 212 can be constructed in the same manner as the tearable tab 210 (e.g., via, folds, scores, and/or perforations in the substrate and cover). The sealing layer 110 can be extend between the tearable tabs 212 and 210, where the tab 210 can be torn to release the sealing layer 110 and the tab 212 can be torn to allow a user to the pull tab 114 (e.g., via the torn tab 212) in the direction 116.

### Activatable Environmental Exposure Indicator: Third Embodiment

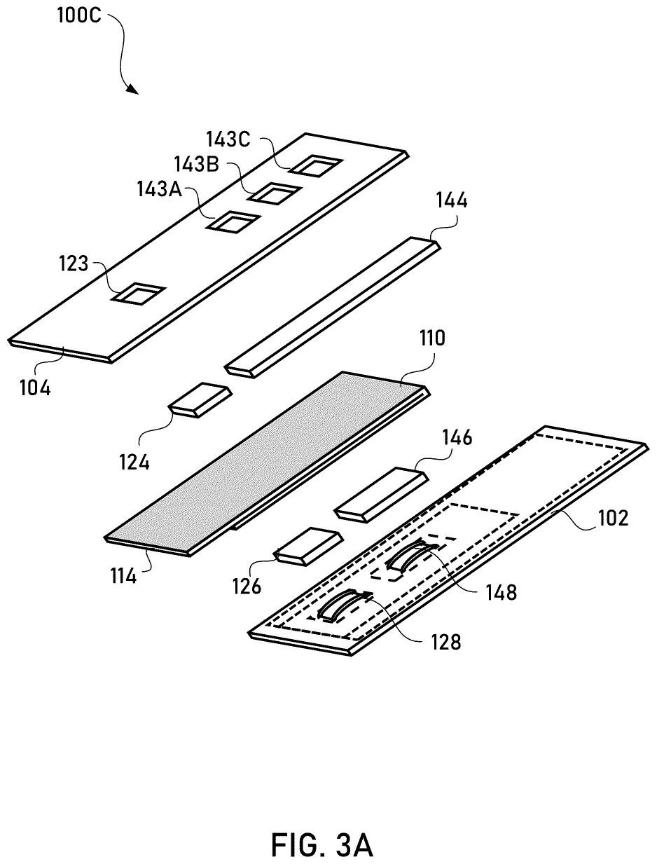

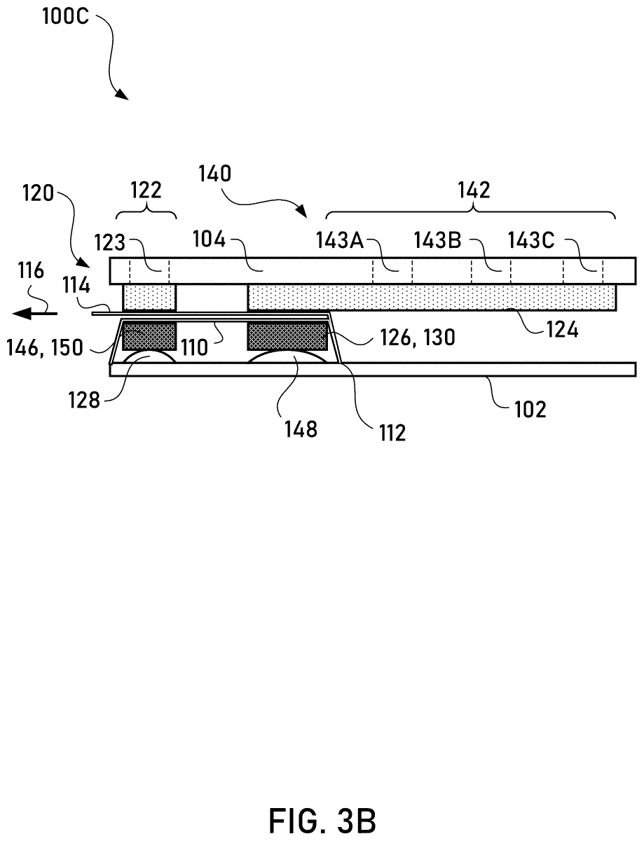

FIG. 3A illustrates an exploded view of a third embodiment of the activatable environmental exposure indicator 100C, according to embodiments of the present disclosure. FIG. 3B illustrates a cross-sectional view of a third embodiment of the activatable environmental exposure indicator 100C, according to embodiments of the present disclosure. Generally speaking, the third embodiment of the activatable environmental exposure indicator 100C operates similarly to the activatable environmental exposure indicator 100A but differs in construction. Except where noted in the following, the discussion of the first embodiment of the activatable environmental exposure indicator 100A and the components, properties, and features thereof, apply to the third embodiment of the activatable environmental exposure indicator 100C.

In the third embodiment of the activatable environmental exposure indicator 100C, the relative orientations of the excursion exposure indicator 120 and the time-dependent exposure indicator 140 are altered with respect to the first embodiment of the activatable environmental exposure indicator 100A and the second embodiment of the activatable environmental exposure indicator 100B. In the third embodiment of the activatable environmental exposure indicator 100C, the first reservoir 126 and the second reservoir 146 are positioned (e.g., on the substrate) closer to one another than in the first embodiment of the activatable environmental exposure indicator 100A and the second embodiment of the activatable environmental exposure indicator 100B. Generally speaking, in the first embodiment of the activatable environmental exposure indicator 100A and the second embodiment of the activatable environmental exposure indicator 100B, the excursion exposure indicator 120 and the time-dependent exposure indicator 140 are configured such that the second payload 150 migrates along the second indicator region 142 in a direction substantially towards the first reservoir 126. In the third embodiment of the activatable environmental exposure indicator 100C, the excursion exposure indicator 120 and the time-dependent exposure indicator 140 are configured such that the second payload 150 migrates along the second indicator region 142 in a direction substantially away from the first reservoir 126 and first indicator region 122.

The above-described positioning of the various features of the activatable environmental exposure indicator 100C provide for a reduction in size of the sealing layer 110. In some examples, the configuration of, or configuration similar to that of the third embodiment of the activatable environmental exposure indicator 100C may provide for less material to be used in the manufacture of an activatable environmental exposure indicator 100C, or other manufacturing advantages. The end of the activatable environmental exposure indicator 100C including the pull tab can also include the pull tab 212 described herein, while the opposing end can be sealed by securing the cover layer 104 to the substrate 102.

### Activatable Environmental Exposure Indicator: Fourth Embodiment

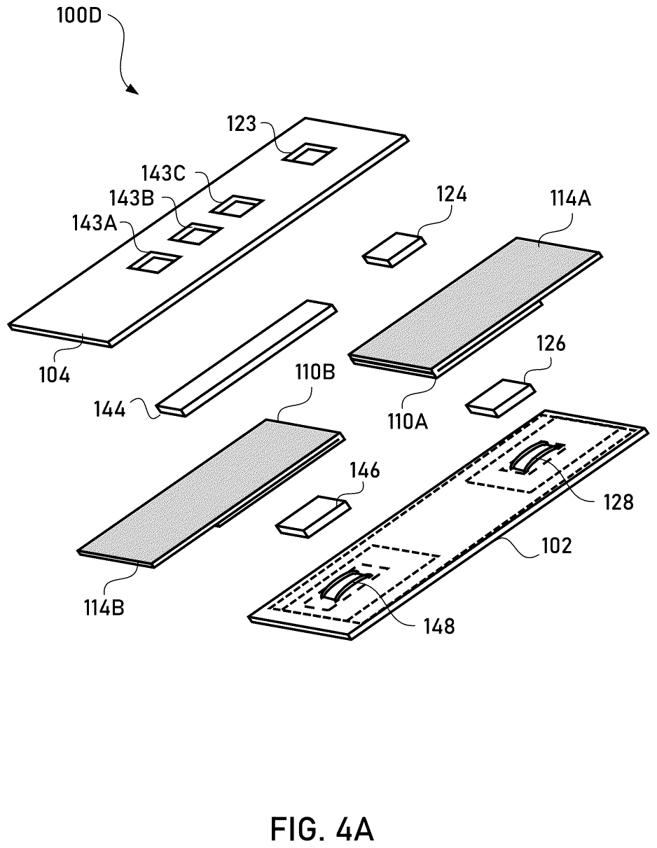

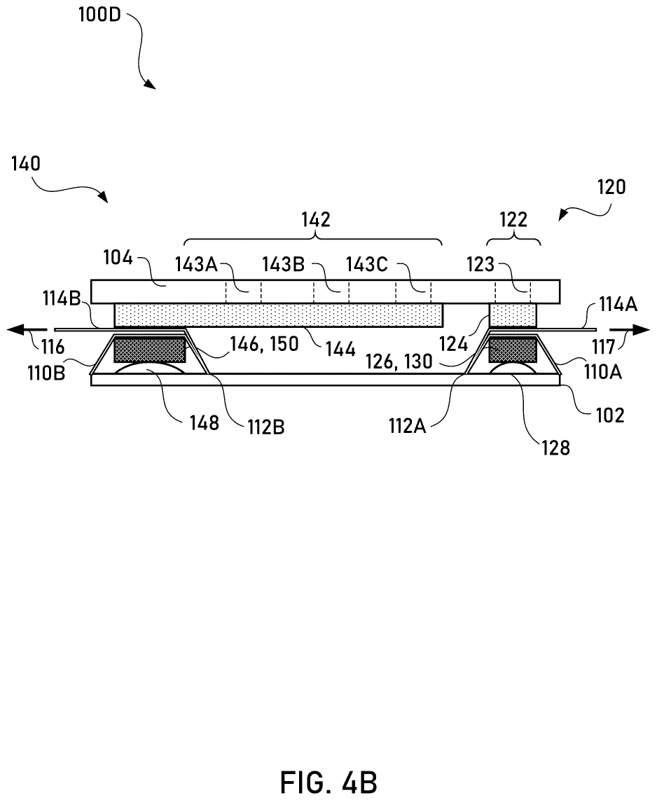

FIG. 4A illustrates an exploded view of a fourth embodiment of the activatable environmental exposure indicator 100D, according to embodiments of the present disclosure. FIG. 4B illustrates a cross-sectional view of the fourth embodiment of the activatable environmental exposure indicator 100D, according to embodiments of the present disclosure. Generally speaking, the fourth embodiment of the activatable environmental exposure indicator 100D operates similarly to the activatable environmental exposure indicator 100A but differs in construction. Except where noted in the following, the discussion of the first embodiment of the activatable environmental exposure indicator 100A and the components, properties, and features thereof, apply to the fourth embodiment of the activatable environmental exposure indicator 100D.

The activatable environmental exposure indicator 100D includes a first sealing layer 110A which seals the first reservoir 126, and a second sealing layer 110B which seals the second reservoir 146. The first sealing layer 110A and the second sealing layer 110B are independently removable. The first sealing layer 110A is removable by applying a force to the first pull tab 114A in a first direction 116, resulting in the disengagement of the first frangible bond 112A. The second sealing layer 110B is removable by applying a force to the second pull tab 114B in a second direction 117, resulting in the disengagement of the second frangible bond 112B. In this manner, the excursion exposure indicator 120 may be activated independently of the time-dependent exposure indicator 140, just as the time-dependent exposure indicator 140 may be activated independently of the excursion exposure indicator 120. In some examples, the ends of the activatable environmental exposure indicator 100D can include the tearable tabs 210 and 212 described herein, where the tearable tab 210 can retain and secure the pull tab 114A and the tearable tab 114B can retain and secure the pull tab 114A. Once the tearable tabs 210 and 212 are torn, a user may pull the pull tab 144A in the direction 117 and may pull the pull tab 114B in the (opposite) direction 116 to remove the sealing layers 110A and 110B, respectively.

### Activatable Environmental Exposure Indicator: Fifth Embodiment

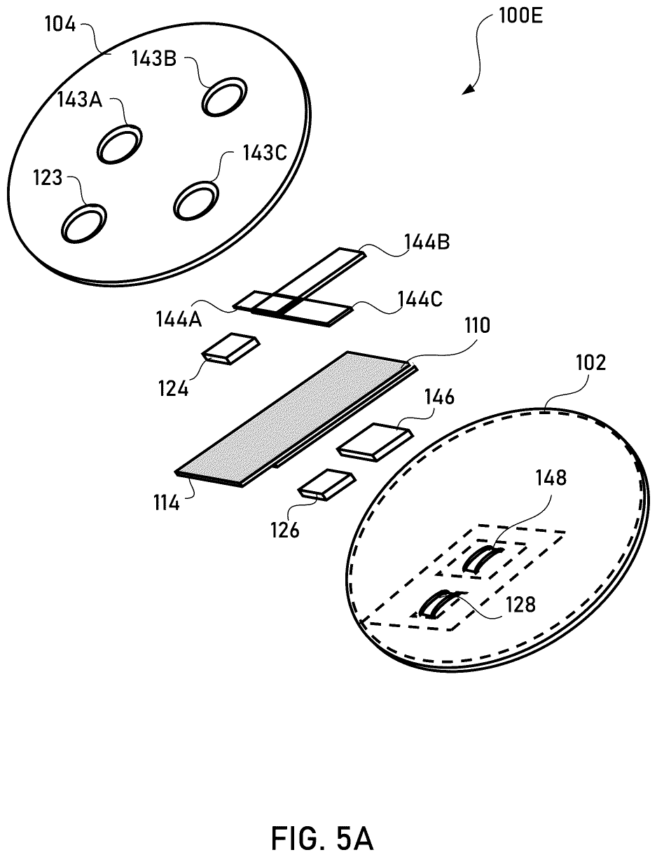

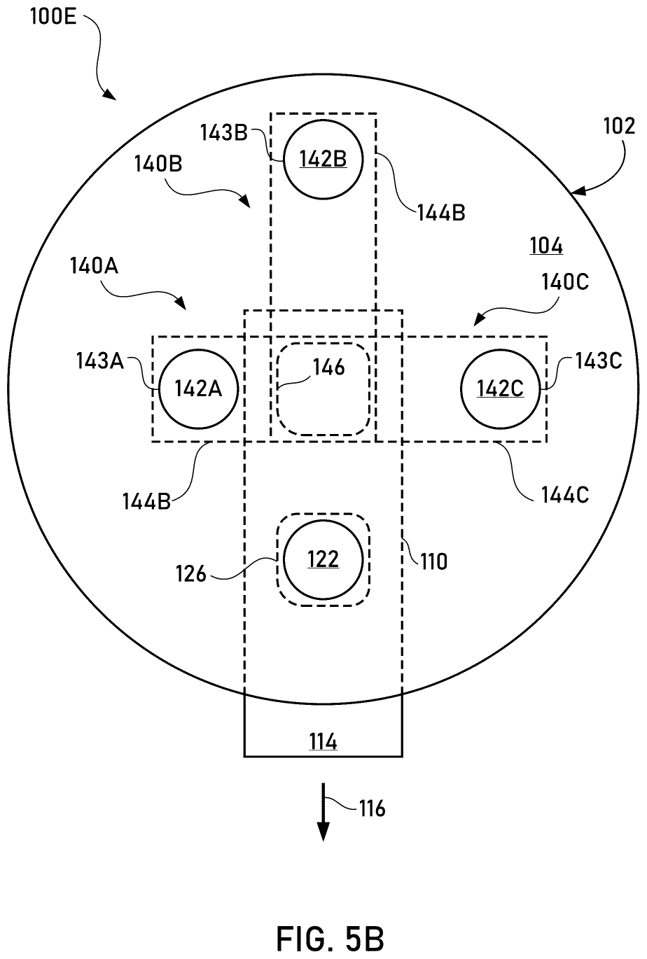

FIG. 5A illustrates an exploded view of a fifth embodiment of the activatable environmental exposure indicator 100E, according to embodiments of the present disclosure. FIG. 5B illustrates a profile view of the fifth embodiment of the activatable environmental exposure indicator 100E, according to embodiments of the present disclosure. Generally speaking, the fifth embodiment of the activatable environmental exposure indicator 100E operates similarly to the activatable environmental exposure indicator 100A but differs in construction. Except where noted in the following, the discussion of the first embodiment of the activatable environmental exposure indicator 100A and the components, properties, and features thereof, apply to the fifth embodiment of the activatable environmental exposure indicator 100E.

The fifth embodiment of the activatable environmental exposure indicator 100E includes a multidirectional time-dependent exposure indicator including a first time-dependent exposure indicator portion 140A, a second time-dependent exposure indicator portion 140B and a third time-dependent exposure indicator portion 140C (collectively time-dependent exposure indicator portions 140A-C).

Each portion time-dependent exposure indicator portion 140A-C includes a respective second wick 144A-C and shares the same second reservoir 146. In one example, a portion of the wicks 144A-C that overlay the reservoir 146 can overlap each other. In one example, the portion of the wicks 144A-C that overlay the reservoir 146 have a non-overlapping configuration. In one example, the activatable environmental exposure indicator 100E can include a separate reservoir for each of the second wicks 144A-C rather than share the same second reservoir 146. Each second wick 144 is oriented radially outwards from the second reservoir 146, and contains a respective second indicator region 142A-C. The second wicks 144A-C are configured such that after the sealing layer 110 is removed and when the second payload 150 is liquefied, the second payload 150 is configured to reach the first second indicator region 142A after a first predetermined period of time, reach the second indicator region 142B after a second predetermined period of time and reach the third second indicator region 142C after a third predetermined period of time. In some examples, the variable timing of the time-dependent exposure indicator portions 140A-C is achieved by where the second wicks 144A-C are configured to have variable lengths, and in other examples the second wicks 142A-C are constructed of different materials, or like materials having different porosities or densities.

This disclosure further contemplates embodiments of activatable environmental exposure indicators similar to the fifth embodiment of the activatable environmental exposure indicator 100E in which more than three second wicks 144 are employed to indicate more than three periods of time for which the activatable environmental exposure indicator has been exposed to the second predetermined environmental exposure or in which fewer than three second wicks 144 are employed to indicate three or less periods of time for which the activatable environmental exposure indicator has been exposed to the second predetermined environmental exposure.

The cover layer 104 can be secured and sealed to the substrate around a perimeter of the activatable environmental exposure indicator 100E, and in some embodiments, the activatable environmental exposure indicator 100E can include the tearable tab 212 which at least partially seals a portion of the perimeter that the pull tab 114 extends through. The tearable tab retains and is secure to the pull tab 114, where the lines and weakness in the tearable tab (e.g., in the substrate 102 and cover layer 104) allow the user to tear the tearable tab from the substrate 102 and cover layer 104 and remove the pull tab 114 by pulling the pull tab in direction 116 away from the activatable environmental exposure indicator 100E. In one example, the activatable environmental exposure indicator 100E can have a circular shape, exemplary embodiments of the activatable environmental exposure indicator 100E can have other shapes.

### Activatable Environmental Exposure Indicator: Sixth Embodiment

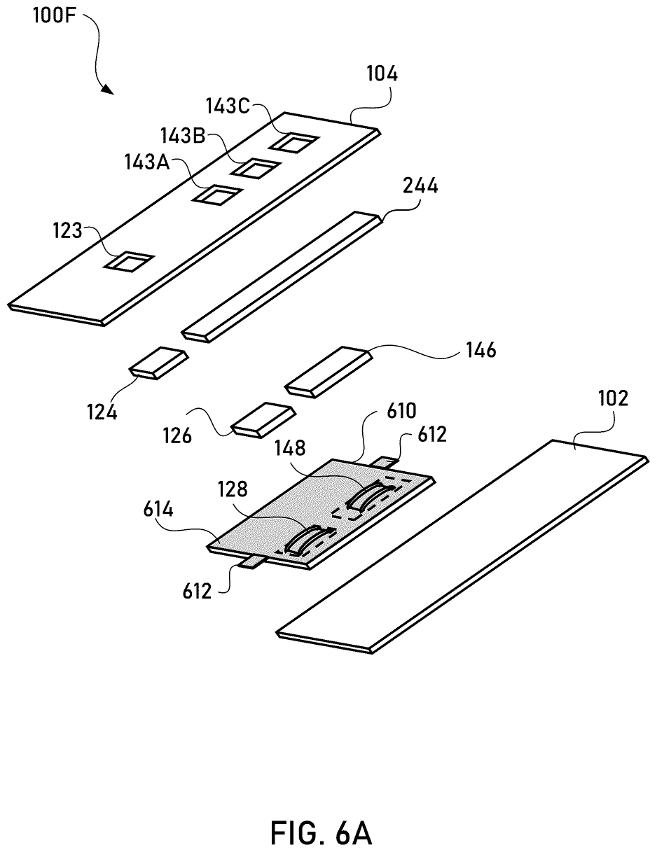

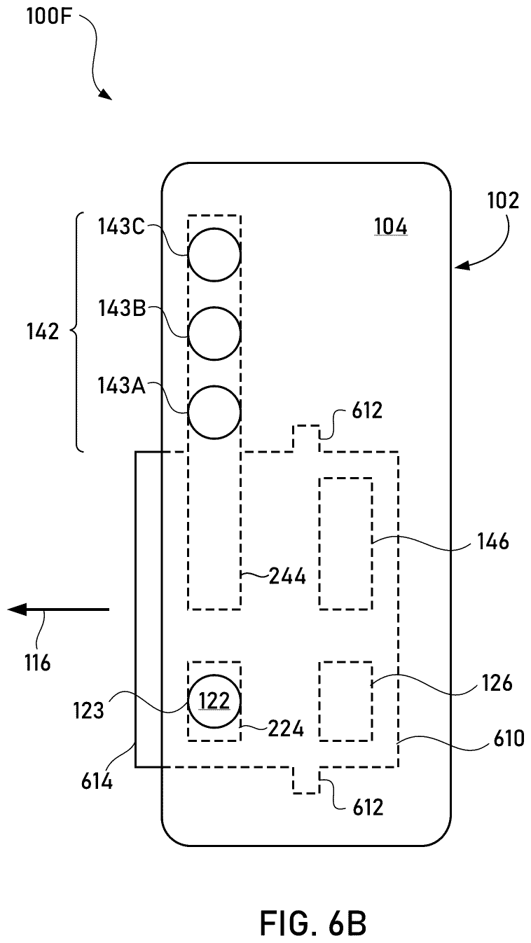

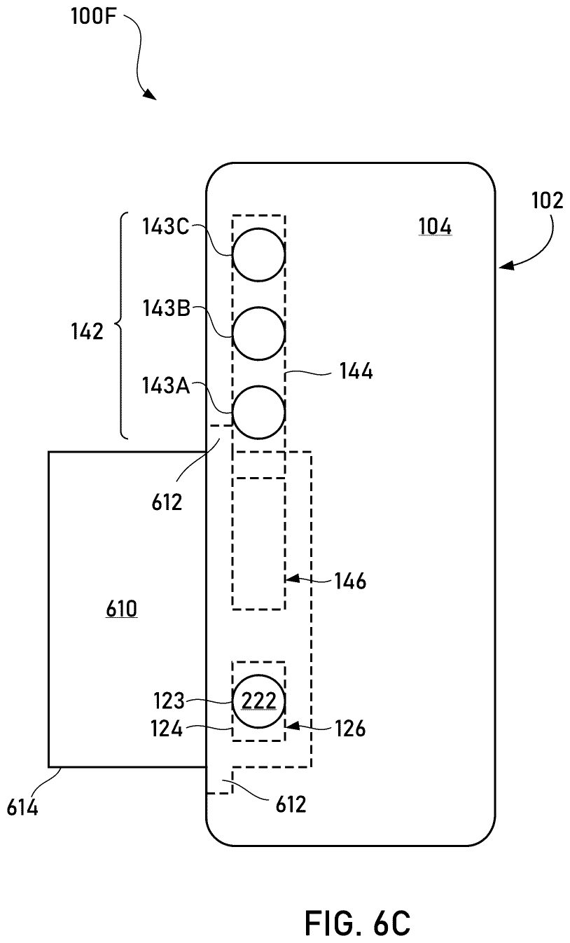

FIG. 6A illustrates an exploded view of a sixth embodiment of the activatable environmental exposure indicator 100F, according to embodiments of the present disclosure. FIGS. 6B-6C illustrate profile views of the sixth embodiment of the activatable environmental exposure indicator 100F, according to embodiments of the present disclosure. Generally speaking, the sixth embodiment of the activatable environmental exposure indicator 100F operates similarly to the activatable environmental exposure indicator 100A but differs in construction. Except where noted in the following, the discussion of the first embodiment of the activatable environmental exposure indicator 100A and the components, properties, and features thereof, apply to the sixth embodiment of the activatable environmental exposure indicator 100F.

The sixth embodiment of the activatable environmental exposure indicator 100F does not include a removable sealing layer but rather a translatable sliding layer 610. The first reservoir 126 and the second reservoir 146 are coupled to, and translatable with the sliding layer 610. The first indicator region 122 and the second indicator region 142 are coupled and fixed relative to the substrate 102 and the cover layer 104. The sliding layer 610 has at least a first position, (e.g., initial position, unactivated position, FIG. 6A) in which first reservoir 126 and the second reservoir 146 are spaced away from the first indicator region 122 and the second indicator region 142, respectively. The sliding layer 610 also has at least a second position (e.g., final position, activated position, FIG. 6B) in which the first reservoir 126 and the second reservoir 146 are aligned with the first indicator region and the second indicator region 142, respectively, such that the first reservoir 126 abuts, or contacts the first indicator region 122 and the second reservoir 146 abuts or contacts the second indicator region 142. The sliding layer 610 may be translated from the first position to the second position, and thus activating the activatable environmental exposure indicator 100F, by applying a force in the direction 116 to a pull tab 164 of the sliding layer 610 which may extend beyond the profile of the activatable environmental exposure indicator 100F defined by the cover layer 104 and the substrate 102.

According to some embodiments, the sliding layer 610, or the pull tab 614 thereof, may extend from an unsealed portion of the activatable environmental exposure indicator 100F, and include stop tabs 612, which abut a sealed portion of the activatable environmental exposure indicator 100F when the sliding layer is in the second position, such that when the force is applied to the pull tab 614 the sliding layer is not entirely removed from the activatable environmental exposure indicator 100F, and that the respective reservoirs (e.g., first reservoir 126, second reservoir 146) are properly aligned with the respective indicator regions (e.g., first indicator region 122, second indicator region 142). In some embodiments, the activatable environmental exposure indicator 100F can include a tearable tab similar to the tearable tab 212 to secure the and retain the pull tab 614, where the tearable tab can be formed by lines of weakness in the substrate 102 and the cover layer 104. The tearable tab can at least partially seal the portion of the activatable environmental exposure indicator 100F where the pull tab 614 extends. Once the tearable tab is torn, the unsealed portion can be formed and a user can pull the pull tab 614 (e.g., via the tearable tab) in the direction 116 to align the first reservoir 126 and the second reservoir 146 with the first wick 224 and the second wick 244, respectively. In some embodiments, at least a portion of the sliding layer 610 can include an adhesive that can be used to adhere the sliding member to an internal and/or external surface of the substrate 102 when the sliding layer 610 is in the second position.

In some embodiments, the sliding layer 610 can include a line of weakness extending along the sliding layer in a direction that is perpendicular to the direction 116. A portion of the sliding layer 610 that extends outwardly from a perimeter of the activatable environmental exposure indicator 100F can be severed, along the line weakness, from a remainder of the sliding layer 610 (e.g., a portion of the sliding layer that is retained within an interior and perimeter of the activatable environmental exposure indicator 100F). The line of weakness can be disposed along the sliding layer 610 so that the stop tabs 612 are positioned between the line of weakness and the first reservoir 126 and the second reservoir 146.

In some embodiments, a portion of the sliding layer 610 that extends outwardly from a perimeter of the activatable environmental exposure indicator 100F can be bent or otherwise wrapped about the substrate 102 and adhered to an exterior surface of the substrate 102. To facilitate the folding or wrapping of the sliding layer 610, the sliding layer 610 can include a fold line extending along the sliding layer 610 in a direction that is perpendicular to the direction 116 and disposed so that the stop tabs 612 are positioned between the fold line and the reservoirs 126 and 146.

In the illustrated embodiment of FIGS. 6A-6C, the reservoirs are coupled to and translatable with the sliding layer 610, however, this disclosure contemplates embodiments in which the indicator regions are coupled to the sliding layer, and the reservoirs are fixed (e.g., relative to the cover layer 104 and substrate 102).

Generally speaking, the sliding layer 610 is configured such that prior to the force being applied to the pull tab 614, the reservoirs (e.g., first reservoir 126, second reservoir 146) are spaced away from the indicator regions (e.g., first indicator region 122, second indicator region 142) such that even if the activatable environmental exposure indicator is exposed to one or both of the first predetermined exposure and the second predetermined exposure, the payloads (e.g., first payload 130, second payload 150) do not migrate into the respective indicator regions (e.g., first indicator region 122, second indicator region 142). In some examples, the reservoirs may initially include frangible bonds which seal the reservoirs to one of the substrate 102 or the cover layer 104 such that if the activatable environmental exposure indicator is exposed to one or more of the first predetermined environmental exposure and the second predetermined environmental exposure, the payloads (e.g., first payload 130, second payload 150) do not flow, leak or diffuse out of the reservoirs (e.g., first reservoir 126, second reservoir 146) prior to activation (e.g., translating the sliding layer from the first position to the second position).

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator, comprising:
a substrate;
a first indicator region and a second indicator region defined on the substrate;
a first reservoir containing a first payload comprising a first liquefiable material configured to liquefy responsive to a first predetermined environmental exposure, a second reservoir containing a second payload comprising a second liquefiable material configured to liquefy responsive to a second predetermined environmental exposure; and
a removable sealing layer, the removable sealing layer preventing flow of the first payload from the first reservoir to the first indicator region when the first liquefiable material is liquefied and prevents flow of the second payload from the second reservoir to the second indicator region when the second liquefiable material is liquefied,
wherein removing the removable sealing layer permits flow of the first payload from the first reservoir to the first indicator region when the first liquefiable material is liquefied and permits flow of the second payload from the second reservoir to the second indicator region when the second liquefiable material is liquefied, and
wherein, responsive to an exposure to the first predetermined environmental exposure after the removable sealing layer is removed, flow of the first liquefiable material from the first reservoir to the first indicator region produces a first observable effect,
wherein, responsive to an exposure to the second predetermined environmental exposure after the removable sealing layer is removed, flow of the second liquefiable material from the second reservoir to the second indicator region produces a second observable effect.

2. The activatable environmental exposure indicator of claim 1, wherein the removable sealing layer includes a frangible bond which couples the removable sealing layer to the substrate.

3. The activatable environmental exposure indicator of claim 1, wherein the removable sealing layer is coupled to the substrate in a manner which prevents evaporation of at least one of the first payload and the second payload.

4. The activatable environmental exposure indicator of claim 1, wherein at least one of:
a) the first reservoir comprises a first wick reservoir portion at least partially saturated with the first payload, and
b) the second reservoir comprises a second wick reservoir portion at least partially saturated with the second payload.

5. The activatable environmental exposure indicator of claim 1, wherein at least one of:
a) a first wick indicator portion is located at the first indicator region, and
b) s a second wick indicator portion is located at the second indicator region.

6. The activatable environmental exposure indicator of claim 5, wherein at least one of:
a) the first reservoir is biased towards the first wick indicator portion by a first biasing element, and
b) the second reservoir is biased towards the second wick indicator portion by a second biasing element.

7. The activatable environmental exposure indicator of claim 1, further comprising a cover layer, the cover layer including transparent portions through which at least a portion of the first indicator region and at least a portion of the second indicator region is viewable through the cover layer.

8. The activatable environmental exposure indicator of claim 1, wherein prior to removal, the removable sealing layer includes a first terminal end attached to a first location on the substrate and an intermediate portion coupled to a second location on the substrate by a frangible bond, the first terminal end and the intermediate portion defining a sealing portion that seals the first and second reservoirs; and a pull tab extending from the intermediate portion to a second terminal end, the pull tab folded over the sealing portion such that the first and second terminal ends are proximate to each other and the seal is disengaged in response to a force being applied to the pull tab.

9. The activatable environmental exposure indicator of claim 8, further comprising a portion of the substrate defined by a line of weakness, wherein second location on the substrate and the frangible bond are disposed in the portion of the substrate defined by the line of weakness, and wherein the portion of the substrate is configured to be torn along the line of weakness, such that when the portion of the substrate is torn along the line of weakness, the frangible bond is disengaged.

10. The activatable environmental exposure indicator of claim 9, further comprising a second portion of the substrate defined by a second line of weakness, wherein the second portion of the substrate is configured to be torn along the second line of weakness, such that when the second portion of the substrate is torn along the line of weakness, the second portion of the substrate separates from a remainder of the substrate but remains attached to the removable sealing layer, such that the sealing layer is removable by drawing the sealing layer out of the activatable environmental exposure indicator via the second portion of the substrate.

11. The activatable environmental exposure indicator of claim 1, wherein at least one of:
a) the first indicator region includes a first migration region, and the first predetermined environmental exposure is an exposure to a temperature above a first predetermined temperature threshold, such that when the first payload is at a temperature above the first predetermined temperature threshold, the first liquefiable material is liquefied and the first payload migrates through the first migration region at a predetermined rate, and when the first payload is at a temperature below the first predetermined temperature threshold, the first liquefiable material is solidified, and the first payload halts migration through the first migration region, such that a distance through the first migration region which the first payload has migrated corresponds to an amount of time which the first payload has been at temperatures above the first predetermined temperature threshold; and
b) the second indicator region includes a second migration region, and the second predetermined environmental exposure is an exposure to a temperature above a second predetermined temperature threshold, such that when the second payload is at a temperature above the second predetermined temperature threshold, the second liquefiable material is liquefied and the second payload migrates through the second migration region at a predetermined rate, and when the second payload is at a temperature below the second predetermined temperature threshold, the second liquefiable material is solidified, and the second payload halts migration through the second migration region, such that a distance through the second migration region which the second payload has migrated corresponds to an amount of time which the second payload has been at temperatures above the second predetermined temperature threshold.

12. The activatable environmental exposure indicator of claim 1, wherein at least one of one of:
a) the first payload is configured to rapidly migrate into the first indicator region and produce the first observable effect responsive to a single exposure to the first predetermined environmental exposure occurring after the removable sealing layer is removed; and
b) the second payload is configured to rapidly migrate into the second indicator region and produce the second observable effect responsive to a single exposure to the second predetermined environmental exposure occurring after the removable sealing layer is removed.

13. The activatable environmental exposure indicator of claim 1 wherein the first predetermined environmental exposure and the second predetermined environmental exposure are selected from a group consisting of: a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

14. The activatable environmental exposure indicator of claim 1, wherein the first liquefiable material and the second liquefiable material comprise materials selected from a group consisting of: a side-chain crystallizable polymer, an alkane, a wax, an alkane wax, esters, other polymeric materials, and combinations thereof.

15. The activatable environmental exposure indicator of claim 1, wherein at least one of:
a) the first payload includes a first indicator material combined with the first liquefiable material; the first indicator material configured to be transported to the first indicator region by the first liquefiable material when the first liquefiable material is liquefied and the removable sealing layer is removed, and produce the first observable effect in the first indicator region, and
b) the second payload includes a second indicator material combined with the second liquefiable material; the second indicator material configured to be transported to the second indicator region by the second liquefiable material when the second liquefiable material is liquefied, and the removable sealing layer is removed and produce the second observable effect in the second indicator region.

16. The activatable environmental exposure indicator of claim 1, wherein the first predetermined environmental exposure is an exposure to a temperature above a first predetermined high temperature threshold, and the second predetermined environmental exposure is an exposure to a temperature above a second predetermined high temperature threshold, lower than the first predetermined high temperature threshold.

17. An activatable environmental exposure indicator, comprising:
a substrate;
a sliding layer, translatable between a first configuration and a second configuration;
a first reservoir, containing a first payload comprising a first liquefiable material configured to liquefy responsive to a first predetermined environmental exposure;
an indicator region, separated from the first reservoir when the sliding layer is in the first configuration,
wherein one of:
a) the first reservoir is coupled to and translatable with the sliding layer, and the indicator region is disposed on the substrate, and
b) the indicator region is disposed on and translatable with the sliding layer and the first reservoir is coupled to the substrate;
wherein, when the first reservoir is in contact with the indicator region and the first liquefiable material is liquefied, the first liquefiable material migrates into the indicator region and produces an observable effect.

18. The activatable environmental exposure indicator of claim 17, further comprising:
a second reservoir, containing a second payload comprising a second liquefiable material configured to liquefy when exposed to a second predetermined environmental exposure and solidify when not exposed to the second predetermined environmental exposure; and
a migration region, separated from the second reservoir when the sliding layer is in the first configuration,
wherein one of:
a) the second reservoir is coupled to and translatable with the sliding layer, and the migration region is disposed on the substrate, and
b) the migration region is disposed on and translatable with the sliding layer, and the second reservoir is coupled to the substrate;
wherein when the sliding layer is in the second configuration, the first reservoir contacts with the indicator region, and the second reservoir contacts the migration region,
wherein, when the second reservoir is in contact with the migration region and the second liquefiable material is liquefied, the second liquefiable material migrates into migration region,
wherein the second liquefiable material is configured to migrate through the migration region at a predetermined rate, such that a distance along the migration region through which the second liquefiable material has migrated corresponds to a cumulative duration of exposures to the second predetermined environmental exposure.

19. The activatable environmental exposure indicator of claim 18, further comprising a cover layer, the cover layer including at least one of a) a first transparent portion through which the indicator region is viewable and b) a second transparent portion through which at least a portion of the migration region is viewable.

20. The activatable environmental exposure indicator of claim 18, wherein the sliding layer comprises an exposed portion which extends beyond the substrate, configured such that when a force is applied in a predetermined direction to the exposed portion, the sliding layer is transitioned from the first configuration to the second configuration.

21. The activatable environmental exposure indicator of claim 20, wherein the sliding layer is coupled to the substrate by a frangible bond, such that the sliding layer is transitioned from the first configuration to the second configuration only when the force exceeds a predetermined force threshold sufficient to disengage the frangible bond.

22. The activatable environmental exposure indicator of claim 18, wherein the first liquefiable material comprises a material selected from a group consisting of: a side-chain crystallizable polymer, an alkane, a wax, an alkane wax, esters, other polymeric materials, and combinations thereof.

23. The activatable environmental exposure indicator of claim 18, further comprising an indicator material, mixed with the first liquefiable material, configured to produce an observable effect in the indicator region when the first liquefiable material liquefies and migrates to the indicator region.

24. The activatable environmental exposure indicator of claim 18, wherein the second liquefiable material comprises a material selected from a group consisting of: a side-chain crystallizable polymer, an alkane, a wax, an alkane wax, esters, other polymeric materials, and combinations thereof.

25. The activatable environmental exposure indicator of claim 18, further comprising an indicator material mixed with the second liquefiable material, configured to indicate a portion of the migration region through which the second liquefiable material has migrated.

26. The activatable environmental exposure indicator of claim 18, wherein the first predetermined environmental exposure is selected from a group consisting of: a temperature excursion above a predetermined temperature, a temperature excursion below a predetermined temperature, an exposure to a particular chemical, an oxygen exposure, an ammonia exposure, an exposure to a particular chemical above a threshold concentration, a predetermined electromagnetic exposure, a humidity exposure, and an exposure to a humidity level above a predetermined threshold.

27. The activatable environmental exposure indicator of claim 18, wherein the second predetermined environmental exposure is selected from a group consisting of: a temperature excursion above a predetermined temperature, a temperature excursion below a predetermined temperature, an exposure to a particular chemical, an oxygen exposure, an ammonia exposure, an exposure to a particular chemical above a threshold concentration, a predetermined electromagnetic exposure, a humidity exposure, and an exposure to a humidity level above a predetermined threshold.

28. The activatable environmental exposure indicator of claim 18, wherein the first predetermined environmental exposure is an exposure to a temperature above a first predetermined high temperature threshold, and the second predetermined environmental exposure is an exposure to a temperature above a second predetermined high temperature threshold, lower than the first predetermined high temperature threshold.
